(19) United States
(12) Patent Application Publication
(10) Pub. No.: US 2024/0134871 A1
(43) Pub. Date: Apr. 25, 2024

(54) SYSTEM AND METHOD FOR REDUCED QUERY LANGUAGE COMPLEXITY

(71) Applicant: Nexthink SA, Prilly (CH)

(72) Inventor: Gregoire Jaunin, Epalinges (CH)

(21) Appl. No.: 18/047,724

(22) Filed: Oct. 18, 2022

(51) Int. Cl. G06F 16/2458; G06F 16/22; G06F 16/2455; G06F 16/25

(52) U.S. Cl. CPC G06F 16/2474; G06F 16/22; G06F 16/2456; G06F 16/25

(57) ABSTRACT

Systems, methods, and computer-readable storage media for a multi-database query. A system receives, in a string format, a query. The system parses the query, the parsed query including: a first table identifier corresponding to a first table, and a first command. The first command is a second table identifier corresponding to a second table and a query keyword which, when executed, combines at least a portion of the first table and at least a portion of the second table. The system then determines at least one common index between the first table and the second table, and executes the parsed query using at least one common index, resulting in the selection of all or a subset of the first table decorated by values computed using the second table. The results are then displayed or otherwise used.

### BACKGROUND

### 1. Technical Field

The present disclosure relates to computer programming, and more specifically to reducing query language complexity for database retrievals.

### 2. Introduction

Query languages are computing languages which can allow users to request and retrieve data from databases and other information systems by sending queries. Condensed and precise query languages allow users to explorer complex datasets and have a better understanding of results.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system in a string format, a query; parsing, via at least one processor of the computer system, the query, resulting in a parsed query, the parsed query comprising: a first table identifier corresponding to a first table; a first command consisting of: a second table corresponding to a second table; a query keyword which, when executed, combines at least a portion of the first table and at least a portion of the second table; determining, via the at least one processor, at least one common index between the first table and the second table; executing, via the at least one processor, the parsed query using the at least one common index, resulting in a subset of the first table; displaying, via a display of the computer system, the subset of the first table.

A system configured to perform the concepts disclosed herein can include: a display; at least one processor; and a non-transitory computer-readable storage medium having instructions stored which, when executed by the at least one processor, causes the at least one processor to perform operations comprising: receiving, in a string format, a query; parsing the query, resulting in a parsed query, the parsed query comprising: a first table identifier corresponding to a first table; a first command consisting of: a second table corresponding to a second table; a query keyword which, when executed, combines at least a portion of the first table and at least a portion of the second table; determining at least one common index between the first table and the second table; executing the parsed query using the at least one common index, resulting in a subset of the first table; displaying, via the display, the subset of the first table.

A non-transitory computer-readable storage medium configured as disclosed herein can have instructions stored which, when executed by at least one processor, cause the at least one processor to perform operations which include: receiving, in a string format, a query; parsing the query, resulting in a parsed query, the parsed query comprising: a first table identifier corresponding to a first table; a first command consisting of: a second table corresponding to a second table; a query keyword which, when executed, combines at least a portion of the first table and at least a portion of the second table; determining at least one common index between the first table and the second table; executing the parsed query using the at least one common index, resulting in a subset of the first table; displaying, via the display, the subset of the first table.

### BRIEF DESCRIPTION OF THE DRAWINGS

FIG. 1 illustrates an example of database interactions;

FIG. 2 illustrates an example of a computer system interacting with multiple databases for a query;

FIG. 3 illustrates an example method embodiment; and

FIG. 4 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Various search engines and search languages exist to search databases of structured data. For example, SQL (Structured Query Language) allows users to search structured databases for specific pieces of data. Such databases usually have data stored in predefined formats and in predefined fields. Thus, an SQL query looks for certain values in predefined fields.

However, as the retrieval and storage of information continues to evolve, information is being stored in many different formats. What is needed are new and advanced ways of searching large collections of data from diverse sources. In particular, when storing large sets of time-series data, the data can be either de-normalized (i.e., all pertinent information can be contained in a single table (e.g., a table of data stored in one or more databases)) or normalized (i.e., the main table linked to smaller tables containing a more limited set of values). These different types of time-series data present a challenge to the ability for users to intuitively generate queries in a natural (but formal) manner, allowing the users to find trends in the data, discover issues, and fix them.

For example, investigating time-series data is often done by projecting data from a main (and very large) table of data ordered by time to a linked (and smaller) table, while computing some aggregates on the main table. The reason for this is that the linked table is generally orders of magnitudes less entries than the main table, making it much more actionable and manageable for users. In an example where a user wants to display a number of crashes per device for a specific date to see if there is a correlation between an update and the number of crashes, the user (using SQL or a similar query language) would need to create a statement joining the main table (with the complete data) with the linked table (which has abbreviated or summarized data), while also summing the crashes by for each unique device according to the date (which acts as a filter). This means that a user would need to know how to express a join, the joining key, the “group by” key, and the syntax to write the operation—a complex operation for most users. Additional complexity can come from the different ways to analyze the data between the two tables, such as the meanings and syntaxes associated with “inner” and “outer” joins, where an inner joins results in the intersection of two tables and an outer joins result in the union of two tables.

Systems configured as disclosed herein can include a query language with commands which, when compiled into machine-readable code, create a query that is executed on one or more databases. Compared to other query language options, the queries prepared by users using the disclosed system features reduced complexity and increased expressiveness thereby lowering the required education for user to navigate complex dataset. Querying data with fewer and simpler queries reduces the time to detect and react to an incident. More specifically, using fewer/simpler queries results in a reduction in time required to compile and execute the query due to a reduced number of commands.

Consider the following example. The system (such as a computer system with one or more processors) can receive, from a user or from another computer system, a query. The query can be, for example, in a string format, and can contain identifiers for two or more tables, where one of the tables is a main/large list of data, and the other database is a linked table containing an abbreviated list. Preferably, the abbreviated list identifies only those data items which have a particular experience, event, or other occurrence. For example, if the main table is a list of application crashes experiences by IOT (Internet of Things) devices, the linked table could be a list of installed devices. Likewise, if the main list of data is a list of airplane flights, the linked table could be a list of planes. The query can also contain a query keyword which, when executed, combines at least a portion of the respective tables. For example, the query keyword can execute an inner join, resulting in the intersection between the two identified tables. Likewise, the query keyword can execute an outer join, resulting in the union of the two tables. The query can also compute values of using the main table for each element of the linked table. For example, (continuing with the above examples) the system can compute the number of crashes per IOT device or the number of hours of flight per plan.

The system, upon executing the query, can automatically identify at least one common index between the first database and the second database using schema information. In the IOT example, the common index could include the device names/identifiers. In the flights example, the common index could include plane serial number.

Once the query is executed on the identified tables using the at least one common index, the result is a list of data meeting the query keyword requirements. That list of data can then be presented to the user who wrote the query, used for additional searches, or otherwise used for future work.

When the query is received (from a user or another computer), the query is in a string format. The system parses the string to identify the various components and aspects of the query, with the result being a parsed query where the tables and the query keyword are identified. If the query contains additional commands (for example, instructions on how to present the query results) or additional filters (such as a data range, specific datatype, specific device type, etc.), those additional commands and filters can be identified. For example, if the user only wanted to collect data associated with actions/instances which occurred on July 1^{st} (a range of a single day) that additional filter can be included in the query and identified as a parsed query component by the system. Likewise, if the user wanted to collect data associated with actions/instances which occurred on July 2-August 2 (a range of a month), that additional filter can likewise be included in the query and identified as a parsed query component. Other filters than dates can also be applied. For example, the filter can identify a device type, specific locations, or any other datatype associated with information stored within the identified tables.

Exemplary additional commands, included in the query, which can be executed by the system, can include commands to list, display, and/or modify the results of the query keyword execution. In other instances, the query keyword can be applied to still other tables. Returning to the IOT example, if a first query keyword were executed between a main database and a linked database, resulting in a list of database results, a second query keyword (which may or may not be the same query keyword) may be executed with respect to a third database, resulting in a combination between the first set of database results and the third database. As another example, an additional command can cause modifying (e.g., filtering or formatting) of the database results, counting the number of database results, and/or sorting the database results.

Preferably, the query keyword is a single word. For example, the query keyword can be a single word (i.e., a contiguous series of characters within a string), and can cause an inner or outer join between the first database and the second database. If the query contains additional query keywords (that is, multiple single-word query keywords each causing a database operation), the additional query keywords can cause the system to execute, for each additional query keyword, an additional combination of the first database and the second database (or additional tables if provided) according to the additional query keyword, resulting in iterative query results. These additional query keywords can result in iterative query results which are added to the previously identified query results. In other instances, the additional query keywords can result in a portion or portions of the already identified query results to be removed/filtered, resulting in a reduced list of query results.

The query language used for the operations disclosed herein is a query language other than SQL (Structured Query Language) since it is not possible to define the proposed table operation in SQL with a single query keyword. In addition, preferably, the main table is a time series list of data, with timestamps being associated with different experiences a given device/actor has undergone. The linked table is then a portion of the main table focused on a specific type of experience or interaction. If, for example, the main table is a list of all crashes associated with IOT devices, the linked table could be a list of IOT devices.

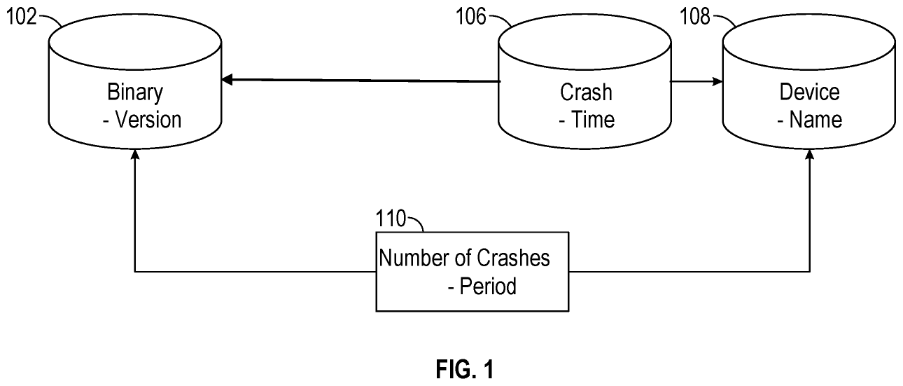

FIG. 1 illustrates an example of database interactions. Binary 102, crash 106, and device 108 are all different tables containing related (but somewhat different) information. In this example, crash 106 is the main table, containing a large amount of data organized as a time-series (that is, with time stamps and ordered according to those time stamps, hence the time illustration). In this example device 108 and binary 102 tables are linked table forms of tables, containing reduced amounts of data. Rather than time, both the device 108 and binary 102 tables are organized based on the names of the devices and binaries respectively whose information is being recorded.

For example, as illustrated, crash 106 table can record all information associated with IOT devices crashing, including the time of when those devices crash. The device 108 linked table may only contain information about the individual devices (not the information about one or more crashes/reboots associated with each individual device), and thus represent a substantially smaller amount of information, in the same manner, while the binary 102 table may represent the version of the application running on the IOT device when crashes happen. The system can, based on a query, calculate the number of crashes 106 during a period 110 based on the devices 110 devices and the binaries 102 as illustrated.

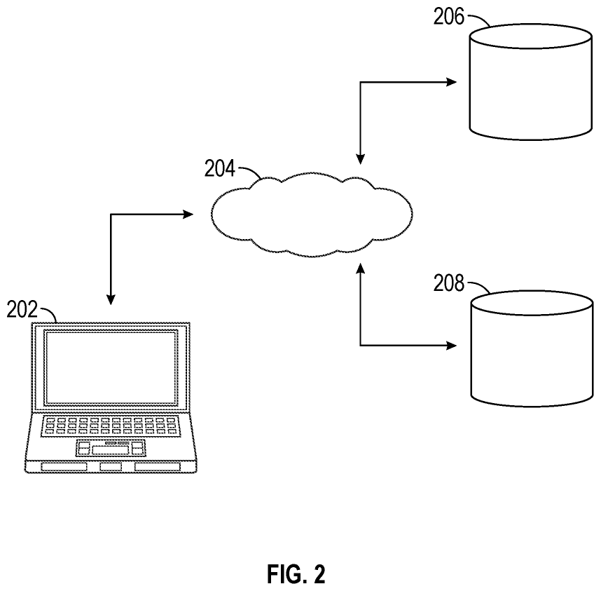

FIG. 2 illustrates an example of a computer system interacting with multiple databases for a query. In this example, the user is operating the computer system 202, and wishes to query various databases 206, 208, which are accessible through a network 204 such as the Internet, or a private computer network. The user uses the computer system 202 to generate a query, which is compiled/transformed by the processor(s) of the computer system 202 into a computer-readable query. The computer system 202 then sends the computer-readable query through the network 204 to the various databases 206, 208 which are being queried, then receives results from the databases 206, 208 in response to the query. Those results can be combined, updated, or modified by the processor(s) of the computer system 202 according to the original query and/or any additional commands provided by the user.

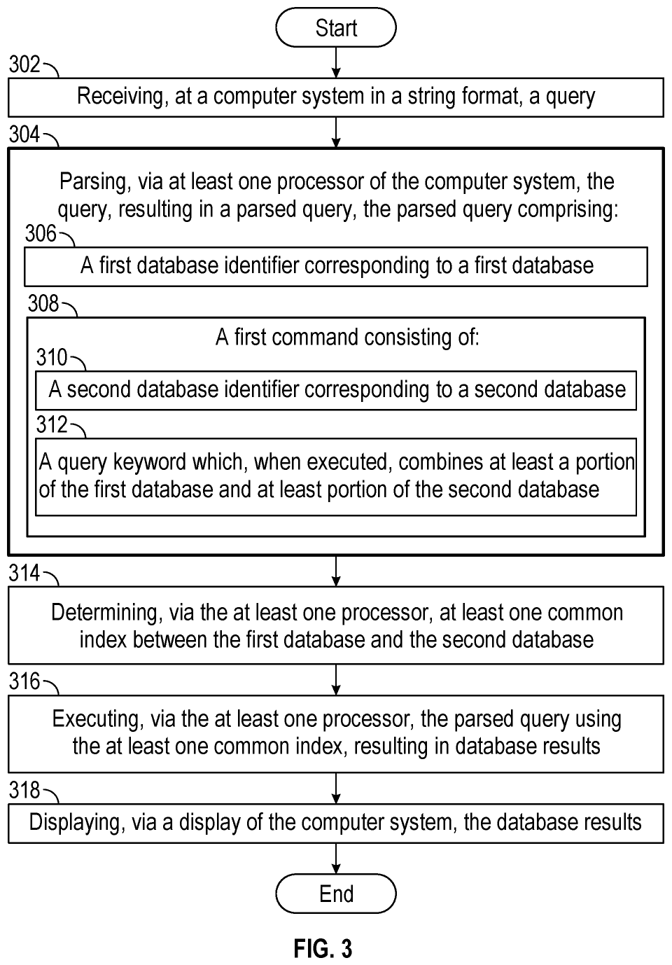

FIG. 3 illustrates an example method embodiment. As illustrated the system receives, in a string format, a query (302). The system then parses, via at least one processor, the query, resulting in a parsed query (304), the parsed query comprising: a first database identifier corresponding to a first database (306); and a first command (308) consisting of: a second table identifier corresponding to a second table (310); and a query keyword which, when executed, combines at least a portion of the first table and at least a portion of the second table (312). The system then determines, via the at least one processor, at least one common index between the first table and the second table (314), and executes, via the at least one processor, the parsed query using the at least one common index, resulting in table results (316). The system then displays, via a display of the computer system, the table results (318).

In some configurations, the parsed query can further include a filter for the first table. For example, the filter can be a date range.

In some configurations, the parsed query can further include at least one command, and the illustrated method can further include modifying, via the at least one processor prior to the displaying of the table results, the table results based on the at least one command.

In some configurations, the first table is a linked table.

In some configurations, the query keyword is an inner join between the first table and the second table.

In some configurations, the query keyword is an outer join between the first table and the second table.

In some configurations, the query keyword is a single word.

In some configurations, the query aggregate can be computed.

In some configurations, the query is in a query language other than SQL (Structured Query Language).

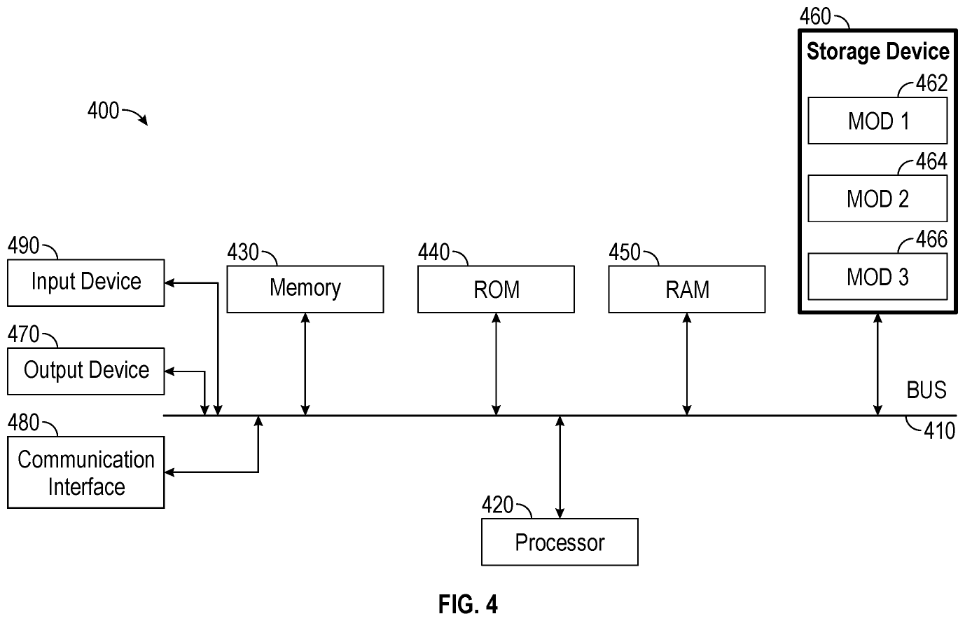

With reference to FIG. 4, an exemplary system includes a general-purpose computing device 400, including a processing unit (CPU or processor) 420 and a system bus 410 that couples various system components including the system memory 430 such as read-only memory (ROM) 440 and random-access memory (RAM) 450 to the processor 420. The system 400 can include a cache of high-speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general-purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

We claim:

1. A method for performing a database query, comprising:
receiving, at a computer system in a string format, a query;
parsing, via at least one processor of the computer system, the query, resulting in a parsed query, the parsed query comprising:
a first table identifier corresponding to a first table;
a first command consisting of:
a second table corresponding to a second table;
a query keyword which, when executed, combines at least a portion of the first table and at least a portion of the second table;
determining, via the at least one processor, at least one common index between the first table and the second table;
executing, via the at least one processor, the parsed query using the at least one common index, resulting in a subset of the first table;
displaying, via a display of the computer system, the subset of the first table.

2. The method of claim 1, wherein the parsed query further comprises a filter for at least one of the first table and the second table.

3. The method of claim 2, wherein the filter is a date range.

4. The method of claim 1, wherein the first table is a linked table.

5. The method of claim 1, wherein the query keyword is an inner join between the first table and the second table followed by a group name of elements of the first table.

6. The method of claim 1, wherein the query keyword is an outer join between the first table and the second table followed by a group name of elements of the first table.

7. The method of claim 1, wherein the query keyword is a single word.

8. The method of claim 1, further comprising:
receiving, at the computer system, an optional query aggregate command which, when executed by the at least one processor, computes an optional value for the subset of the first table based on values of the second table.

9. A system comprising:
a display;
at least one processor; and
a non-transitory computer-readable storage medium having instructions stored which, when executed by the at least one processor, causes the at least one processor to perform operations comprising:
receiving, in a string format, a query;
parsing the query, resulting in a parsed query, the parsed query comprising:
a first table identifier corresponding to a first table;
a first command consisting of:
a second table corresponding to a second table;
a query keyword which, when executed, combines at least a portion of the first table and at least a portion of the second table;
determining at least one common index between the first table and the second table;
executing the parsed query using the at least one common index, resulting in a subset of the first table;
displaying, via the display, the subset of the first table.

10. The system of claim 9, wherein the parsed query further comprises a filter for at least one of the first table and the second table.

11. The system of claim 10, wherein the filter is a date range.

12. The system of claim 9, wherein the first table is a linked table.

13. The system of claim 9, wherein the query keyword is an inner join between the first table and the second table followed by a group name of elements of the first table.

14. The system of claim 9, wherein the query keyword is an outer join between the first table and the second table followed by a group name of elements of the first table.

15. The system of claim 9, wherein the query keyword is a single word.

16. The system of claim 9, wherein the non-transitory computer-readable storage medium has additional instructions stored which, when executed by the at least one processor, causes the at least one processor to perform operations comprising:
receiving an optional query aggregate command which, when executed by the at least one processor, computes an optional value for the subset of the first table based on values of the second table.

17. A non-transitory computer-readable storage medium having instructions stored which, when executed by at least one processor, cause the at least one processor to perform operations comprising:
receiving, in a string format, a query;
parsing the query, resulting in a parsed query, the parsed query comprising:
a first table identifier corresponding to a first table;
a first command consisting of:
a second table corresponding to a second table;
a query keyword which, when executed, combines at least a portion of the first table and at least a portion of the second table;
determining at least one common index between the first table and the second table;
executing the parsed query using the at least one common index, resulting in a subset of the first table;
displaying, via the display, the subset of the first table.

18. The non-transitory computer-readable storage medium of claim 17, wherein the parsed query further comprises a filter for at least one of the first table and the second table.

19. The non-transitory computer-readable storage medium of claim 18, wherein the filter is a date range.

20. The non-transitory computer-readable storage medium of claim 17, wherein the first table is a linked table.
